(19) United States
(12) Patent Application Publication
(10) Pub. No.: US 2026/0012393 A1
(43) Pub. Date: Jan. 8, 2026

(54) METHOD AND APPARATUS FOR HANDLING MULTIPLEXED PACKETS IN WIRELESS COMMUNICATION SERVICE

(71) Applicant: SAMSUNG ELECTRONICS CO., LTD., Suwon-si (KR)

(72) Inventors: Hyunkoo YANG, Suwon-si (KR); Hakju LEE, Suwon-si (KR)

(21) Appl. No.: 19/263,332

(22) Filed: Jul. 8, 2025

(30) Foreign Application Priority Data
Jul. 8, 2024 (KR) 10-2024-0089804
Nov. 11, 2024 (KR) 10-2024-0159389

(51) Int. Cl. H04L 41/0894; H04L 65/65; H04W 28/02; H04W 56/00

(52) U.S. Cl. CPC H04L 41/0894; H04L 65/65; H04W 28/0268; H04W 56/0015

(57) ABSTRACT

The disclosure relates to a 5G or 6G communication system for supporting a higher data transmission rate. A method performed by a user equipment (UE) is provided. The method comprises transmitting, to an application function (AF) entity for a media streaming, a first message for requesting a dynamic policy applied to a media session for a media and receiving, from the AF entity for the media streaming, a second message including information associated with the dynamic policy, wherein the first message includes first information on a media stream for the media, and second information on a media protocol corresponding to media stream, and wherein a quality of service (QOS) for the media stream is based on the first information.

### CROSS-REFERENCE TO RELATED APPLICATIONS

This application is based on and claims priority under 35 U.S.C. 119 to Korean Patent Application Nos. 10-2024-0089804 and 10-2024-0159389, filed on Jul. 8, 2024 and Nov. 11, 2024, in the Korean Intellectual Property Office, the disclosures of which are herein incorporated by reference in their entirety.

### BACKGROUND

### 1. Field

The disclosure relates to a method and an apparatus for handling packets in consideration of media characteristics in a mobile communication system. Specifically, the disclosure relates to a method and an apparatus for handling multiplexed packet streams in a wireless communication service.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

Provided according to an embodiment of the disclosure is an apparatus and a method capable of effectively providing services in a mobile communication system.

According to an embodiment of the disclosure, a method performed by a user equipment (UE) is provided. The method comprises transmitting, to an application function (AF) entity for a media streaming, a first message for requesting a dynamic policy applied to a media session for a media and receiving, from the AF entity for the media streaming, a second message including information associated with the dynamic policy, wherein the first message includes first information on a media stream for the media, and second information on a media protocol corresponding to media stream, and wherein a quality of service (QOS) for the media stream is based on the first information.

A method performed by an application function (AF) entity for a media streaming is provided. The method comprises receiving, from a user equipment (UE), a first message for requesting a dynamic policy applied to a media session for a media and transmitting, to the UE, a second message including information associated with the dynamic policy, wherein the first message includes first information on a media stream for the media, and second information on a media protocol corresponding to media stream, and wherein a quality of service (QOS) for the media stream is based on the first information.

A user equipment (UE) is provided. The UE comprises at least one transceiver, at least one processor communicatively coupled to the at least one transceiver, and at least one memory, communicatively coupled to the at least one processor, storing instructions executable by the at least one processor individually or in any combination to cause the UE to transmit, to an application function (AF) entity for a media streaming, a first message for requesting a dynamic policy applied to a media session for a media, and receive, from the AF entity for the media streaming, a second message including information associated with the dynamic policy, wherein the first message includes first information on a media stream for the media, and second information on a media protocol corresponding to media stream, and wherein a quality of service (QOS) for the media stream is based on the first information.

An application function (AF) entity for a media streaming is provided. The AF entity comprises at least one processor and at least one memory, communicatively coupled to the at least one processor, storing instructions executable by the at least one processor individually or in any combination to cause the AF entity to receive, from a user equipment (UE), a first message for requesting a dynamic policy applied to a media session for a media, and transmit, to the UE, a second message including information associated with the dynamic policy, wherein the first message includes first information on a media stream for the media, and second information on a media protocol corresponding to media stream, and wherein a quality of service (QOS) for the media stream is based on the first information.

According to an embodiment of the disclosure, an apparatus and a method capable of effectively providing services in a wireless communication system can be provided.

Advantageous effects obtainable from the disclosure may not be limited to the above-mentioned effects, and other effects which are not mentioned herein may be clearly understood from the following description by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example fifth-generation system (5G system, 5GS) architecture for a media service in a wireless communication system according to the disclosure;

FIG. 2 illustrates an example conceptualized (generalized) media deliver architecture for providing a media service in a wireless communication system according to the disclosure;

FIG. 3 illustrates an example packetization process of an image data unit in a wireless communication system according to the disclosure;

FIG. 4 illustrates an example packet header in a wireless communication system according to the disclosure;

FIG. 5 illustrates an example RTP extension header according to the disclosure;

FIG. 6 illustrates an example media service provision procedure according to the disclosure;

FIG. 7 illustrates an example quality of service (QOS) provision method for each media stream according to the disclosure;

FIG. 8 illustrates an example packet filter operation according to the disclosure;

FIG. 9 illustrates an example RTCP packet filter operation according to the disclosure;

FIG. 10 illustrates an example of a structure of a base station according to an embodiment of the disclosure;

FIG. 11 illustrates an example of a structure of a UE according to an embodiment of the disclosure; and

FIG. 12 illustrates an example of a structure of a core network entity according to an embodiment of the disclosure.

### DETAILED DESCRIPTION

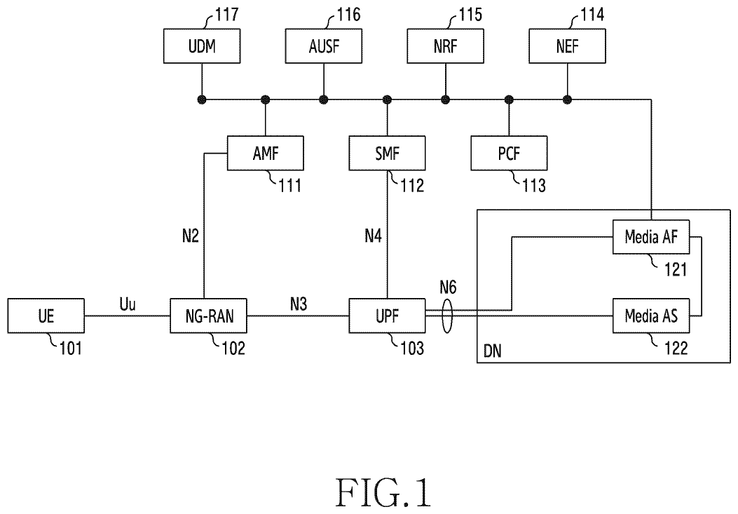

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In describing the disclosure below, a detailed description of known functions or configurations will be omitted when it is determined that the description may make the subject matter of the disclosure unnecessarily unclear.

For the same reason, in the accompanying drawings, some elements may be exaggerated, omitted, or schematically illustrated.

Hereinafter, the operation principle of the disclosure will be described in detail in conjunction with the accompanying drawings. The terms which will be described below are terms defined in consideration of the functions in the disclosure. The terms in the disclosure may be different according to users, intentions of the users, or customs, and therefore, the definitions of the terms should be made based on the contents throughout the specification.

In the disclosure, terms referring to network entities or network functions, terms referring to messages, terms referring to identification information, and the like are illustratively used for the sake of descriptive convenience. Therefore, the disclosure is not limited by the terms as described below, and other terms referring to subjects having equivalent technical meanings may also be used.

In the following description of the disclosure, terms and names defined in the 5G system standards will be used for the sake of convenience, but the disclosure is not limited by these terms and names and may also be applied in the same way to systems that conform other standards.

Hereinafter, the operation principle of the disclosure will be described in detail with reference to the accompanying drawings.

In describing the embodiments of the disclosure, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The embodiments of the disclosure are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description of the disclosure, terms and names defined in the 3rd generation partnership project long term evolution (3GPP LTE) and 3GPP 5G standards will be used for the sake of descriptive convenience. However, the disclosure is not limited by these terms and names, and may be applied in the same way to systems that conform other standards.

Hereinafter, exemplary embodiments of the disclosure will be described in detail with reference to the accompanying drawings. It should be noted that, in the accompanying drawings, the same or like elements are designated by the same or like reference signs as much as possible. Also, it should be noted that the following accompanying drawings of the disclosure are provided to help an understanding of the disclosure and the disclosure is not limited to configurations or arrangements illustrated in the drawings of the disclosure.

According to an embodiment, a method of a service control apparatus for media streaming support in a mobile communication system may include a method including an operation of receiving media streaming service configuration information from an application service provider, an operation of receiving detail information of a packet flow for a media streaming service from a UE or a media streaming server, and an operation of providing network configuration information for the media streaming service to a network.

It will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The instructions which execute on a computer or other programmable data processing apparatus to cause a series of operational steps to be performed on the computer or other programmable data processing apparatus to produce a computer implemented process may provide steps for implementing the functions specified in the flowchart block(s).

Furthermore, each block in the flowchart illustrations may represent a module, segment, or portion of code, which includes one or more executable instructions for implementing the specified logical function(s). It should also be noted that the functions noted in the blocks of the embodiments may occur out of the order. For example, two blocks shown in succession may in fact be executed substantially concurrently (e.g., in parallel) or the blocks may sometimes be executed in the reverse order, depending upon the functionality involved.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the following description, 5G (new radio:) or a 5G (NR) system may be described by way of example, but the embodiments of the disclosure may also be applied to other communication systems having similar technical backgrounds or channel types. In addition, based on determinations by those skilled in the art, the disclosure may be applied to other communication systems (e.g., long term evolution (LTE) systems) through some modifications without significantly departing from the scope of the disclosure.

Hereinafter, embodiments of the disclosure will be described in detail in conjunction with the accompanying drawings.

The disclosure relates to a method and an apparatus for network resource allocation for each media and packet handling policy application in a mobile communication system. For example, the disclosure relates to a method and an apparatus for media service support including a real-time communication service and a media streaming service.

According to an embodiment, media data configuring the media service may be encapsulated in the form of packets in the media delivery apparatus and transmitted to one or more service data flows (SDFs), and the transmitted packets may be delivered to a media reception apparatus via the network. The service data flow refers to a flow of packets that satisfy the same conditions and may be defined, for example, using the 5-tuple (a source Internet protocol (IP) address, a destination IP address, a source port number, a target port number, and protocol). The network may allocate network resources in a unit of service data flow according to the media service provider's request and apply packet handling policies. Here, the network may identify packets belonging to a specific service data flow by using a packet filter, and information for the operation of the packet filter may be, for example, the 5-tuple described above.

An extended reality (XR) refers to a technology that delivers content generated by computing technology in an environment where the real and virtual are combined, through interaction between a user of a wearable device and an object (or machine). The XR may generate an extended reality by utilizing virtual reality (VR) and augmented reality (AR) technologies individually or in combination. The XR is expected to have applications in various fields, including education, healthcare, manufacturing, and more. High-performance computing power and graphics handling power to display large amounts of real-time, three-dimensional (3D) images are critical to realize the XR. Furthermore, display technologies need to evolve, and technologies such as fifth-generation mobile communications are prerequisites for efficiently transmitting large amounts of data with ultra-low latency.

In addition to images and audio, an XR content may include media data in a variety of formats, such as graphical objects and haptics. The media data may be encoded using different encoders depending on the format thereof, and the encoded media data may be converted into one or more media transport streams during a packetization process. The media transport stream may be referred to as a collection of packets that may be grouped by functions provided by a media transport protocol. For example, the service data flow included in a media service may include one or more media transport streams. For example, the media transport stream may correspond to a real time protocol (RTP) stream defined as an RTP packet stream having an identical synchronization source (SSRC) field value.

According to an embodiment, the media transport stream may have a transport characteristic (traffic characteristics) different depending on an included media. For example, the transport characteristic may correspond to at least one of a maximum transport bit rate, an acceptable transport latency, or an acceptable packet error rate. Accordingly, a network that allocates resources and applies packet handling policies in a unit of service data flow may not be able to provide optimized QOS for a service data flow that includes multiple media streams. Therefore, in order for the network to handle a service data flow including multiple media transport streams according to the transport characteristic of each media, information is required to categorize the packets included in the service data flow for each media transport stream. Here, the information for identifying the media transport streams may be determined by negotiation (or information exchange) between a media transport apparatus and a media reception apparatus at the time of service initiation. Accordingly, a procedure for notifying the network of the media transport stream identification information according to a result of the negotiation is required.

According to an embodiment, a method of a service control apparatus for media service support in a mobile communication system may include an operation of receiving media service configuration information from an application service provider, an operation of receiving detail information for media streaming identification from a UE or a media server, and an operation of providing network configuration information for the media service to a network.

According to embodiments disclosed herein, through media stream-based network resource configuration and packet handling, services may be provided seamlessly using various types of media, including XR services.

The disclosure provides a method for network resource allocation for each media and network policy application in a mobile communication system.

### [5G System Structure]

The wireless communication system according to various embodiments of the disclosure may correspond to, for example, a 5G system (5GS). The 5G system may include a 5G radio access network (next generation radio access network (NG-RAN)) and a 5G core network (5GC). The 5GS interworks with existing LTE and may also be connected to a non-3GPP radio access technology such as Wi-Fi. The 5GC is present between the NG-RAN and an external packet data network (PDN) and may provide users with various forms of data services, including voice. Control plane components in the 5GC may be identified by virtualized network functions (VNFs), and communication between VNFs may be identified as service consumption by a VNF through an application programming interface (API) supported by another VNF that provides the service. An API-based communication interface between VNFs is called a service-based interface (SBI).

FIG. 1 illustrates an example 5G system (5GS) architecture for a media service in a wireless communication system according to the disclosure.

Referring to FIG. 1, the 5GS according to an embodiment may include a user equipment (UE) 101, a next generation (NG)-radio access network (RAN) 102 including a base station, a user plane function (UPF) apparatus (or entity) 103, an access and mobility management function (AMF) apparatus 111, a session management function (SMF) apparatus 112, a policy control function (PCF) apparatus 113, a network exposure function (NEF) apparatus 114, an NF repository function (NRF) apparatus 115, an authentication server function (AUSF) apparatus 116, an unified data management (UDM) apparatus 117, a media application function (media AF) apparatus 121, and/or a media application server (media AS) apparatus 122.

Entities or apparatuses included in the 5GS are not limited to the example described above and 5GS may include fewer or more configurations than those illustrated in FIG. 1. In addition, each apparatus may be referred to as a network entity, network function, or network function apparatus.

According to an embodiment, each network function (NF) of the 5GS is described as a “network entity” or “network function” itself. However, it will be understood by those skilled in the art that a network function (NF) and/or an NF apparatus may be implemented on one or more specific servers, and that two or more NFs performing the same operation may also be implemented on a single server.

According to an embodiment, an NF or more than one NF may be implemented as a single network slice in some cases. The network slice may be generated based on a specific purpose. For example, the network slice may be configured for groups of subscribers to provide the same type of service to specific groups of subscribers based on maximum rates and data usage and/or guaranteed minimum transmission rates. In addition, the network slice may be implemented for various purposes. The network slice is obvious to those skilled in the art and thus a description thereof will be omitted.

According to an embodiment, FIG. 1 illustrates an interface between each node. A Uu interface may be used between the UE 101 and the NG-RAN 102, an N2 interface may be used between the NG-RAN 102 and the AMF 111, an N3 interface may be used between the NG-RAN 102 and the UPF 103, an N4 interface may be used between the SMF 112 and the UPF 103, and an N6 interface may be used between the UPF 103 and the Media AF 121 and Media AS 122 located in a Data Network (DN). The interfaces described above are defined in the 3GPP standard specification, and thus an additional description thereof will be omitted. An interface between the Media AF 121 and Media AS 122 and the UE will be described with reference to a media architecture described below.

### [Generalized Media Delivery Architecture]

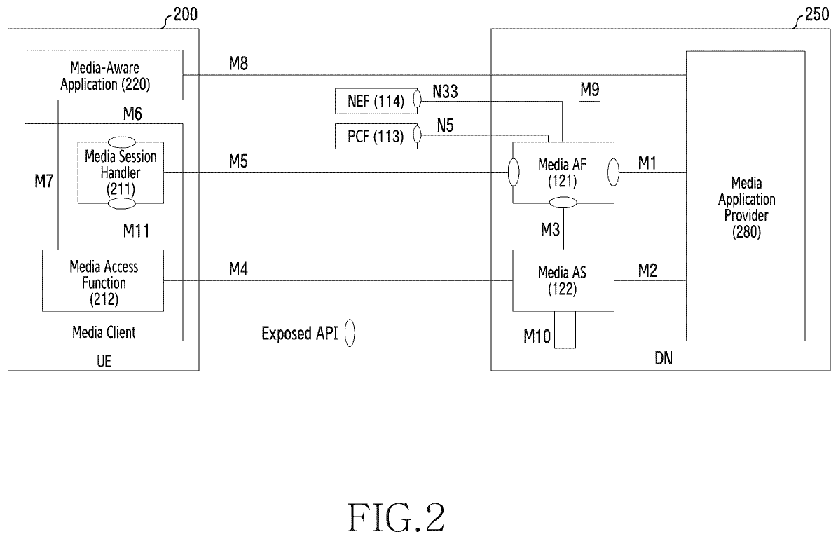

FIG. 2 illustrates an example generalized media deliver architecture for providing a media service in a wireless communication system according to the disclosure.

Referring to FIG. 2, the main functional elements of the conceptualized media delivery architecture are as follows:
Media AF 121: Application function for media service provision
Media AS 122: Application server for media transport
Media Client 210: UE internal function for media transport The Media Client 210 may include following sub-functions as logical functions.
Media Session Handler 211: Internal function of UE 200 communicating with Media AF 121 for establishment and control of media transport session.
Media Access Function 212: Internal function of UE 200 communicating with Media AS 122 for access to and transport of media content. The media access function may have detailed functions such as a media transport protocol, a media codec, and/or a metadata handler, for example.

According to an embodiment as illustrated in FIG. 2, a Media Session Handler 211 and a Media Access Function 212 provide application programming interfaces (APIs) to each other through an M11 interface and to a Media-Aware Application 220 through M6 and M7 interfaces, respectively, but this is merely an example. For example, depending on implementation options, functions of the element functions may be provided by the Media-Aware Application 220 or other components of the UE 200, in which case the M11, M6, and M7 interfaces may not be present.
Media-Aware Application 220 may correspond to an application executed in the UE 200 and may utilize at least one of APIs provided by the Media Session Handler 211 or the Media Access Function 212 for media transport. For example, the Media-Aware Application may be replaced by the term, such as an application for identifying media, an application associated with media, or an application for media.

According to an embodiment, components of the generalized media delivery architecture described above may communicate with each other using at least one of the following interfaces. However, the description below is only an example, and the disclosure is not limited thereto.
M1: corresponds to an interface between a Media Application Provider 280 and the Media AF 121 and may be used for configuration provision of media transport services.
M2: corresponds to an interface between the Media Application Provider 280 and the Media AS 122 and may be used for providing or receiving media data to the Media AS 122 or from the Media AS 122.
M3: corresponds to an interface between the Media AF 121 and the Media AS 122 and may be used for media session handling associated with the configuration of the Media AS 121 or media transport.
M4: corresponds to an interface between the Media Access Function 212 of the UE and the Media AS 122 and may be used for the Media Access Function 212 to receive media data from the Media AS 122 or to transmit media data to the Media AS 122.
M5: corresponds to an interface between the Media Session Handler 211 of the UE and the Media AF 121 and may be used for media session handling associated with media transport.
M6: corresponds to an interface between the Media-Aware Application 220 and the Media Session Handler 211 and may be used for configuring the Media Session Handler 211.
M7: corresponds to an interface between the Media-Aware Application 220 and the Media Access Function 212 and may be used for controlling the Media Access Function 212.
M8: corresponds to an interface between the Media-Aware Application 220 of the UE and the Media Application Provider 280 and may be used for media application service logic control.
M9: corresponds to an interface between a first instance and a second instance of the Media AF 121 and may be used for interworking between Media AF instances.
M10: corresponds to an interface between a first instance and a second instance of the Media AS 122 and may be used for media relay and handling between Media AF instances.
M11: corresponds to an interface between the Media Session Handler 211 and the Media Access Function 212 and may be used for configuring the Media Session Handler 211 or the Media Access Function 212.

According to an embodiment, the Media AF 121 and the Media AS 122 which correspond to functions located in a data network 250 may communicate with the UE 200 through the N6 interface defined in the 5GS.

According to an embodiment, a function (e.g., the Media AF 121) located in an operator's external data network (DN) may communicate with a 5G network function (e.g., a network entity) through the NEF 114 using the N33 interface, and a function (e.g., the Media AF 121) located in an operator's trusted DN may communicate directly with the 5G network function.

According to an embodiment, the Media AF 121 located in the operator's trusted DN may communicate with the PCF 113 using the N5 interface. The communication between the Media AF 121 and the NEF 114, or between the Media AF 121 and the PCF 113, may be a process of consuming network services using APIs provided by the NEF 114 or the PCF 113. For example, the media AF 121 may use an Nnef_AFSessionWithQOS service provided by the NEF 114 or an Npcf_PolicyAuthorization service provided by the PCF 113 to request a traffic handling policy configuration, including QoS parameters, for a media transport session between the Media Access Function 212 of the UE 200 and the Media AS 122. For example, the Media AF 121 may subscribe to a network event notification service, and may be notified or alerted that a network event has occurred when an associated situation is issued by the network. For example, the event notification may be delivered directly to the Media AF 121 from the network function (e.g., the PCF 113 or UPF 103) associated with the event, or may be delivered through the NEF 114.

Media services according to various embodiments of the disclosure may include at least one of the following three main scenarios. However, this is only an example, and the disclosure is not limited to the scenarios described below.
Downlink (DL) Streaming: The network provides the media and the UE performs a function of consuming the media (e.g., the UE outputs the received media content (or information associated with the media))
Uplink (UL) Streaming: The UE provides the media and the network performs a function of using the media (e.g., the network collects the media content (or information associated with the media) and transmits the media content to other apparatuses (e.g., other UEs, network entities, or base stations).
Real-Time Communication (RTC): Exchange media between RTC endpoints The RTC endpoints may be the UE or the network (e.g., a network located in a media transport path between a first UE and a second UE may collect media contents (or, information associated with the media), process the same (e.g., codec conversion), and deliver the same).

The functions and interfaces of the generalized media delivery architecture as illustrated in FIG. 2 may provide different functions depending on the scenario described above. For example, the M4 interface described above may be used to transmit and/or receive media data between the UE 200 and the Media AS 122 in the downlink streaming and uplink streaming services, but may be used to transmit and/or receive media data between the UE 200 and the RTC AS 122 or between the UE 200 and a second UE (not shown) in the RTC service.

### [Protocol Data Unit (PDU) Set]

As described above, data units configuring media data may be split into multiple packets without being preserved during packetization for network transport.

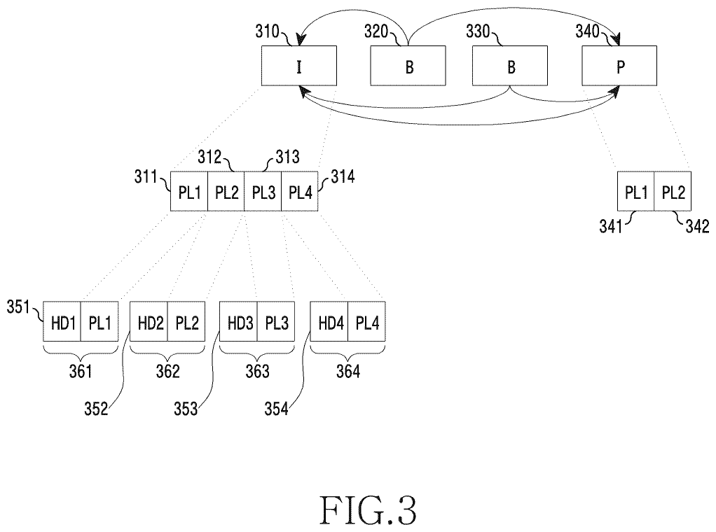

FIG. 3 illustrates an example packetization process of an image data unit in a wireless communication system according to the disclosure. For example, general image data may include a group of pictures (GOP) that includes an intra-coded picture (I-picture), a predictive-coded picture (P-picture), and/or a bidirectional-coded picture (B-picture). For example, an image set may include at least one I-picture.

As used herein, the term picture group may be replaced by the terms “image set”, “image data set”, image dataset”, “media data set”, “media dataset”, or “image set”.

Referring to FIG. 3, for example, one picture set may include one I frame 310, two B frames 320 and 330, and one P frame 340. For example, the I frame 310 may be split into four payloads, PL1 311, PL2 312, PL3 313, and PL4 314, and transmitted through four packets 361, 362, 363, and 364, each including a payload. For example, the four packets 361, 362, 363, and 364 may include headers (HD1 351, HD2 352, HD3 353, and HD4 354) corresponding to each payload (e.g., PL1 311, PL2 312, PL3 313, and PL4 314). Hereafter, a set of payloads split from a single media data unit may be referred to as a protocol data unit (PDU) Set.

However, the number (e.g., 4) of payloads (PLs) included in the frame 310 is merely an example and the number of the PLs may vary.

According to an embodiment, four payloads PL1 311, PL2 312, PL3 313, and PL4 314, configuring the I frame 310, may configure one PDU Set (e.g., the first PDU set). Two payloads PL1 341 and PL2 342, configuring the P frame 340, may configure another PDU Set (e.g., the second PDU set).

According to an embodiment, the packet may include a header and a payload. The header may include information required to handle the packet in the network and transmit the packet to a destination thereof, and may include extended headers for additional functions such as a PDU set identification, for example. For example, the payload may include information required to handle the media data at the reception end, and may include a separate payload header depending on a method of handling the media data. The network may utilize data included in the packet header and payload to identify the packet.

According to an embodiment, in case that the network identifies packets including a PDU belonging to the same PDU Set, the network may handle the packet based on the PDU Set. For example, in case that the amount of communication exceeds a handling capacity of the network, a packet loss may occur. By handling packets based on the PDU Set, the QoS degradation may be minimized by reducing or minimizing the number of lost PDU Sets relative to the number of lost packets. Network equipment (e.g., network entities) that support the PDU Set-based packet handling may require a function to identify packets belonging to the same PDU Set and a function to identify a handling method to be applied to the packets in the PDU Set.

### [PDU Set Marking]

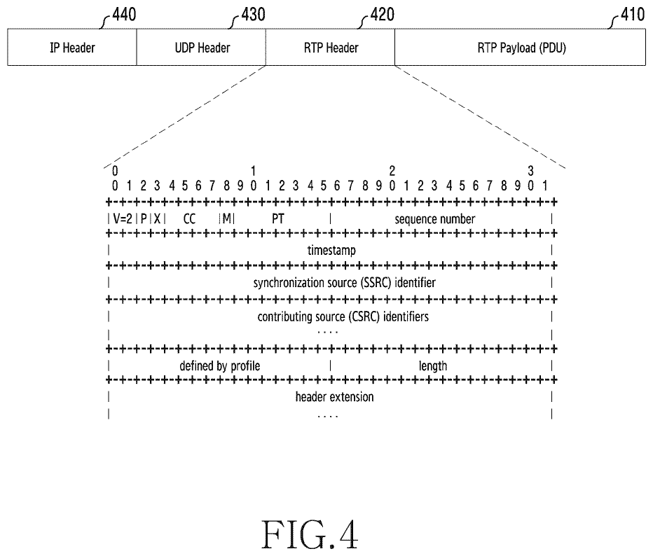

FIG. 4 illustrates an example packet header in a wireless communication system according to the disclosure.

Referring to FIG. 4, a packet header according to an embodiment may additionally include an RTP header 420, a user datagram protocol (UDP) header 430, and an IP header 440 to transport a PDU 410. For example, the RTP header 420 may include an RTP extension header.

According to an embodiment, first 12 octets or 12 bytes of the RTP header 420 may be included in all RTP packets, and contributing source (CSRC) identifiers may be added by middle equipment (middle box), such as a mixer. For example, each field of the RTP header 420 has following meanings.
version (V): A 2 bit-field indicating a version of the RTP. The RTP following IETF RFC 3550 has a value of 2.
padding (P): A 1 bit-field having a value of 1 in case that the RTP packet includes a padding octet.
extension (X): A 1 bit-field having a value of 1 in case that the RTP packet includes an extension header.
CSRC count (CC): A 4 bit-field indicating the number of CSRC identifiers located after a fixed header of 12 octets.
marker (M): A 1 bit-field the usage of which is determined by an RTP profile. By way of example, in case that one video frame is split into multiple RTP packets and transmitted, only an M field value of the last RTP packet in the RTP packets may be configured to be 1.
payload type (PT): A 7 bit-field for identifying an RTP payload format. A field value may be determined using static mapping, which is determined by the RTP profile, or dynamic mapping, which is determined in an out-band manner using the Session Description Protocol (SDP).
sequence number (SN): A 16 bit-field increasing by 1 whenever each RTP packet is transported. This may be used for loss detection and packet order restoration at a receiver.
timestamp: A 32-bit field that may indicate a time point of acquiring or reproducing a data sample included in the corresponding RTP packet.
SSRC: A 32 bit-field indicating an identifier of a synchronization source.
CSRC: A 32 bit-field indicating an identifier of a contribution source.

The media service according to an embodiment of the disclosure may include at least one media transport session, and information about the media transport session may include 5-tuple (e.g., a source internet protocol (IP) address, destination IP address, a source port number, a destination port number, and a transport protocol).

Therefore, packets that use the RTP/UDP/IP protocol and have the same source/destination IP address values in the IP header 440 and the same source/destination port number values in the UDP header 430, such as the packets illustrated in FIG. 4, may be identified as belonging to a single media transport session. For example, one media transport session may include at least one RTP stream. Here, the RTP stream collectively refers to RTP packets having the same SSRC field value in a single media transport session, each of which may include at least one of media data or data for loss recovery. For example, the data for loss recovery may correspond to redundant data, forward error correction (FEC) repair data, or the like.

According to an embodiment, the network equipment (e.g., a network entity) may acquire or identify, from at least one of the packet header or the PDU in the packet, information for identifying a PDU Set including the packet and/or information for determining a handling method to be applied to the packets configuring the PDU Set. The media transport session according to an embodiment of the disclosure may use the packet header and the payload header to deliver information (e.g., information for identifying a PDU Set and/or information for determining a handling method to be applied to the packets configuring the PDU Set). The format of a specific header and payload used to deliver information and information included in the header and payload may vary depending on the type of protocol used for the media transport session and/or a profile operating the protocol for the media transport session. Hereafter, the method used to deliver a PDU Set related information by the media transport session may be referred to as a PDU Set Marking method. The PDU Set Marking method according to an embodiment of the disclosure may include the RTP extension header. Furthermore, the PDU Set Marking method may be included in network configuration information supporting the PDU Set-based packet handling.

### [RTP Header Extension]

The RTP extension header may be specified by a Uniform Resource Identifier (URI).

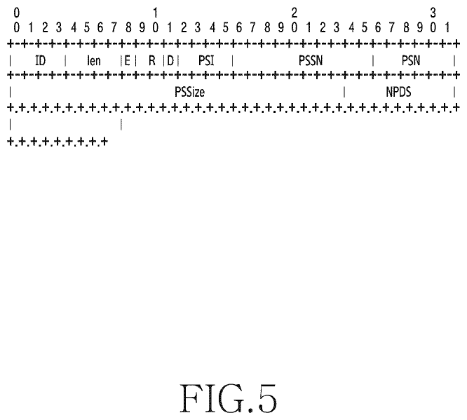

FIG. 5 illustrates an example RTP extension header according to the disclosure. For example, the RTP extension header illustrated in FIG. 5 may correspond to an extension header for the PDU Set Marking, and an URI corresponding to the extension header may be “urn: 3gpp:pdu-set-marking:rel-18”.

According to an embodiment, the format and usage of each field in the extension header is as follows:
ID (4 bits): A local identifier of the RTP extension header.
len (4 bits): A value acquired by subtracting 1 from the byte length of the RTP extension header after this field. By way of example, a len field with a value of 0 indicates that there is 1 byte of data thereafter.
End PDU of the PDU Set [E] (1 bit): A flag having a value of 1 only for a last PDU of the PDU Set and having a value of 0, otherwise.
Reserved [R] (2 bits): A field reserved for later use.
End of Data Burst [D] (1 bit): A flag having a value of 1 only for a last PDU of the data burst and having a value of 0, otherwise.
PDU Set Importance [PSI] (4 bits): A field indicating the relative importance of an associated PDU Set. Smaller values indicate higher importances.
PDU Set Sequence Number [PSSN] (10 bits): This indicates a serial number of an associated PDU Set.
PDU Sequence Number within a PDU Set [PSN] (6 bits): This indicates a serial number of an associated PDU in the associated PDU Set.
PDU Set Size [PSSize] (24 bits): This indicates a byte length of the associated PDU Set. This field may be optionally present, and the presence of this field may be determined during a session description protocol (SDP) negotiation process.
Number of PDUs in the PDU Set [NPDS] (16 bits): This indicates the number of PDUs included in the associated PDU Set. This field may be optionally present, and the presence of this field may be determined during the SDP negotiation process.

The value of the ID field and the presence of the PSSize field and NPDS field may be determined during the SDP negotiation process. For example, an m-line (media description) in the negotiated SDP may include the following extmap properties:
a=extmap: 1 “urn:3gpp:pdu-set-marking:rel-18” pdu-set-size.

In this case, an RTP stream included in the m-line including the extmap properties may include an RTP extension header identified by “urn:3gpp:pdu-set-marking:rel-18”, and here, a value of the ID field in the RTP extension header may be configured to be “1”, indicating the presence of the PSSize field.

### [Media Service Provision Procedure]

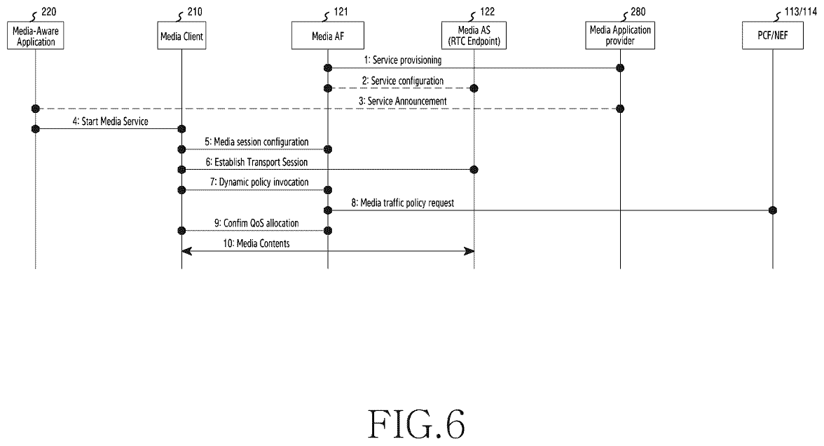

FIG. 6 illustrates an example of a media service provision process according to the disclosure.

Referring to FIG. 6, the media service according to an embodiment may be provided to a user through the following process.

Service Provisioning: In operation 1, the Media Application Provider 280 and the Media AF 121 may establish a provisioning session (e.g., a session for the media service) and perform function configuration for the media service. For example, the function for the media service may include a dynamic policy invocation. For example, provisioning information for configuring the dynamic policy invocation may include policy template information that may be referenced for the dynamic policy invocation. The policy template according to an embodiment of the disclosure may include information for media stream identification. For example, the dynamic policy may be referenced when the Media AF 121 requests a QoS from the network.

Media AS configuration: In operation 2, the Media AF 121 may configure the Media AS 122 based on the provisioning information when necessary. When the Media AF 121 configures the Media AS 122, the information for the media stream identification may be provided.

Service Announcement: In operation 3, the Media Application Provider 280 may deliver Service Announcement information to the Media-Aware Application 220 operating on the user apparatus. For example, the Service Announcement information may include a path through which Service Access Information (or service access information) may be acquired. For example, the service access information may include a provisioning session identifier and configuration information for a dynamic policy invocation.

Start Media Service: In operation 4, the Media-Aware Application 220 may request the Media Client 210 to handle media (e.g., media data) for the media service selected by the user. For example, the service access information and/or the path through which the service access information may be acquired may be delivered to the Media Client 210. For example, the request for media handling may include the service access information and/or the path through which the service access information may be acquired.

Media Session Configuration: In operation 5, in case that the Media Client 210 knows the path through which the service access information may be acquired, the Media Client 210 may acquire the service access information based on the path.

Establish Transport Session: In operation 6, the media transport session for media delivery is established. For example, a media transport session for media data between the Media Client 210 and the Media AS 122 may be established. The media transport session establishment process in the downlink streaming service may include a process for acquiring information about individual media streams configuring the media service. For example, the information about individual media streams may include at least one of parameters used to encode the media, a media transport characteristic, or uniform resource locator (URL) information for acquiring the media. The media transport session establishment process in the RTC service may include a process of negotiating (e.g., an SDP Offer/Answer process) access information (e.g., the IP address and the port number) and/or a detailed media-related parameter that enables exchange of media data between RTC ends. When exchanging media data using the RTP protocol, a detailed parameter for filtering media streams may be determined. For example, a mapping between the URI and the identity (ID) field values in the RTP extension header to be used when filtering media streams using the RTP extension header may be determined at this operation. For example, in case that media stream filtering is performed using the SSRC field value of the RTP header, the SSRC field value for each media stream may be determined as the SDP parameter at this operation.

Dynamic policy invocation: In operation 7, the Media Client 210 may request the Dynamic policy configuration to be applied to the media transport session from the Media AF 121. For example, the Dynamic policy configuration invocation may include a provisioning session identifier, an Application Flow Description, and/or a policy template identifier. The Application Flow Description according to an embodiment of the disclosure may include information for identifying one or more media streams included in the service data flow.

Media traffic policy request: In operation 8, the Media AF 121 may request a media transport traffic handling policy from the PCF 113 or the NEF 114. The media transport traffic handling policy according to an embodiment of the disclosure may include information for identifying one or more media streams included in the service data flow. Confirm QoS Allocation: In operation 9, the Media Client 210 may identify (or distinguish) a result of the dynamic policy configuration requested from the Media AF 121. A policy configuration result identification message may include information about a dynamic policy configuration situation (e.g., Accepted, Rejected, etc.) and/or instructions (e.g., bitrate, whether media stream-specific QoS is supported, etc.) for the dynamic policy.

Media Contents: In operation 10, the Media Client 210 may configure an internal parameter according to a response from the Media AF 121 and initiate media transmission or reception.

Although the above embodiment shows the Media Client 210 requesting the Dynamic policy configuration from the Media AF 121, the Media AS 122 may request the Dynamic policy configuration based on a mobile communication service provider's policy or a request from the Media Application Provider 280. That is, there may be many different entities requesting the Dynamic policy configuration. For example, the Media Client 210 may request the Dynamic policy configuration. For example, the Media Application Provide 280 may request the Dynamic policy configuration. For example, the Media AS 122 may request the Dynamic policy configuration.

### [QOS Flow Mapping]

The mobile communication system according to the disclosure may configure a QoS flow in a unit of media stream. For example, the QoS flow may be a logical smallest unit to which the same packet handling policy applies.

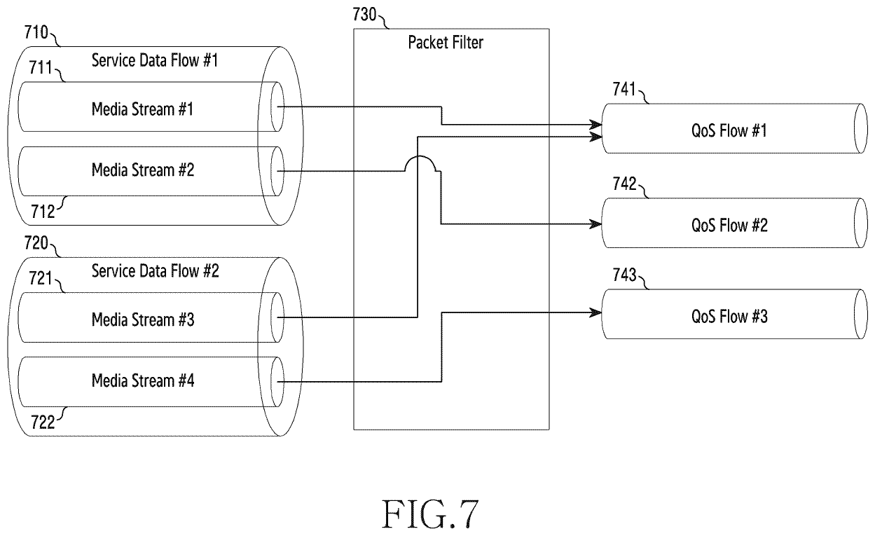

FIG. 7 illustrates an example QoS provision method for each media stream according to the disclosure.

Referring to FIG. 7, the media service according to an embodiment may be provided to the user through a first service data flow 710 and a second service data flow 720. However, it will be obvious to those skilled in the art that the number (e.g., two) of service data flows is only an example and may vary.

According to an embodiment, the first service data flow 710 may include a first media stream 711 and a second media stream 712, and the second service data flow 720 may include a third media stream 721 and a fourth media stream 722.

According to an embodiment, the network apparatus having received the first service data flow 710 and the second service data flow 720 may use a packet filter 730 to categorize input packets in units of media streams and map the categorized streams back to QoS flows. For example, it may be assumed that the first media stream 711 and the third media stream 721 include voice data, the second media stream 712 includes image data, and the fourth media stream 722 includes text data.

In this case, the network may configure a first QoS flow 741 with the first media stream 711 and the third media stream 721 including voice data, and may configure a second QoS flow 742 and a third QoS flow 743 with the second media stream 712 including image data and the fourth media stream 722 including text data, respectively. For example, a new header may be added to a packet input to the packet filter 730 for packet delivery between apparatuses (or entities) included in the network. For example, the added header may include the PDU Set-related information described above.

According to an embodiment, the packet filter 730 may conceptually include two levels of packet filters. For example, a first packet filter may perform packet filtering based on information of the IP packet header and the transport protocol (e.g., a User Datagram Protocol (UDP) or Transmission Control Protocol (TCP)) header, and a second packet filter may perform packet filtering based on information of an application layer protocol (e.g., RTP) header.

According to an embodiment, the packet filter 730 may be located in the User Plane Function (UPF) apparatus 103 of the 5G system in FIG. 1, and a detailed parameter for packet filtering and QoS flow mapping may be acquired through another network function. For example, the Session Management Function (SMF) apparatus 112 and/or the Policy Control Function (PCF) apparatus 113 may provide the detailed parameter to the UPF apparatus 103. In addition, the Media AF 121 may provide the detailed parameter for the packet filtering and a QoS requirement for each media stream to the PCF apparatus 113 directly or through the Network Exposure Function (NEF) apparatus 114.

In the media service according to the disclosure, the service data flow may include the media transport session, but this does not mean that all packets in the service data flow belong to the media transport session. For example, the service data flow may further include a second application layer protocol (e.g., an RTCP (RTP control protocol), a session traversal utilities for NAT (STUN) packet, and/or a service packet (e.g., an internet control message protocol (ICMP) message) of the IP layer, which is different from a first application layer protocol (e.g., the RTP) applied to the media transport session. In case that the reception packet does not include the PDU Set-related information, the network according to the disclosure may receive, from the Media AF 121, information for generating an additional header including the PDU Set information described above together with the detailed parameters for packet filtering and the QoS requirements for each media stream described above.

### [SDP Negotiation]

In a real-time communication system according to the present disclosure, a mapping relationship between a media transmission session and a media stream may be negotiated through an SDP Offer/Answer exchange process. For example, a first RTC end (or, terminal) may transmit an SDP Offer including media parameters to be used for a real-time communication service to a second RTC end via a network. The second RTC end (or, terminal) that receives the above SDP Offer may generate an SDP Answer for the received SDP Offer, and may transmit the generated SDP answer to the first RTC end through the network. In the SDP examples described below, the ellipsis ( . . . ) indicates a portion of the SDP that is not shown in the embodiment according to the present disclosure and is not part of the SDP.

In a real-time communication system according to the present disclosure, each media transmission session may include one media stream. As an example, the following [Table a] shows an example of SDP Offer in a real-time communication service using voice data and video data.

TABLE a

...
c=IN IP4 198.51.100.1
m=audio 10000 RTP/AVP 97
a=rtpmap:97 AMR/8000/1
m=video 10002 RTP/AVP 99
a=rtpmap:99 H264/90000

Referring to [Table a], for example, the IPV4 address of the first RTC end is 198.51.100.1 (c=IN IP4 198.51.100.1), voice data using the AMR codec is transmitted and received using the RTP protocol in a media transmission session using the transmission and reception port number 10000, and video data using the H.264 codec will be transmitted and received using the RTP protocol in a media transfer session using the transmission and reception port number 10002. As an example, the following [Table b] shows an example of an SDP Answer for the SDP Offer of the above [Table a].

TABLE b

...
c=IN IP4 198.51.110.1
m=audio 20000 RTP/AVP 97
a=rtpmap:97 AMR/8000/1
m=video 20002 RTP/AVP 99
a=rtpmap:99 H264/90000

Referring to [Table b], for example, the IPV4 address of the second RTC end is 198.51.110.1 (c=IN IP4 198.51.110.1). voice data using the proposed AMR codec is transmitted and received using the RTP protocol in a media transmission session using the transmission and reception port number 20000, and a response is identified that video data using the proposed H.264 codec is transmitted and received using the RTP protocol in a media transfer session using the transmitting and receiving port number 20002

At this time, for example, based on (or, with respect to) the received packet of the first RTC end, the first media transmission session may include an RTP packet with a transmission IP address of 198.51.110.1, a transmission port number of 20000, a reception IP address of 198.51.100.1, and a reception port number of 10000, and the second media transmission session may include an RTP packet with a transmission IP address of 198.51.110.1, a transmission port number of 20002, a reception IP address of 198.51.100.1, and a reception port number of 10002.

In a real-time communication system according to the present disclosure, a media transmission session may include one or more media streams having different media formats. As an example, the following [Table c] shows an example of SDP Offer in a real-time communication service using voice data and video data.

TABLE c

...
c=IN IP4 198.51.100.1
a=group:BUNDLE foo bar
m=audio 10000 RTP/AVP 97
a=mid:foo
a=rtpmap:97 AMR/8000/1
a=extmap 1 urn:ietf:params:rtp-hdrext:sdes:mid
m=video 0 RTP/AVP 99
a=mid:bar
a=bundle-only
a=rtpmap:99 H264/90000
a=extmap 1 urn:ietf:params:rtp-hdrext:sdes:mid

Referring to [Table c], for example, the IPV4 address of the first RTC end is 198.51.100.1 (c=IN IP4 198.51.100.1), and voice data using the AMR codec and video data using the H.264 codec are transmitted and received together using the RTP protocol in a media transmission session using the transmission and reception port number 10000. At this time, the above voice data and video data constitutes a BUNDLE group (a-group: BUNDLE foo bar). Voice data is identified by the RTP extension header (a=extmap) with a MID value of “foo” (a=mid: foo), and video data is identified by the RTP extension header (a-extmap) with a MID value of “bar”. Additionally, “setting the port number of the media description (m=video 0 RTP/AVP 99) indicating the video data to 0, and including a=bundle-only attribute” means to propose that, for example, the video data is not used if the second RTC end that received the SDP Offer shown in [Table c] above does not support the BUNDLE group. As an example, the following [Table d] shows an example of an SDP Answer for the SDP Offer of the above [Table c].

TABLE d

...
c=IN IP4 198.51.110.1
a=group:BUNDLE foo bar
m=audio 20000 RTP/AVP 97
a=mid:foo
a=rtpmap:97 AMR/8000/1
a=extmap 1 urn:ietf:params:rtp-hdrext:sdes:mid
m=video 20000 RTP/AVP 99
a=mid:bar
a=bundle-only
a=rtpmap:99 H264/90000
a=extmap 1 urn:ietf:params:rtp-hdrext:sdes:mid

Referring to [Table d], for example, the IPV4 address of the second RTC end is 198.51.110.1 (c=IN IP4 198.51.110.1). the BUNDLE group is accepted and a response is identified that voice data using the AMR codec and video data using the H.264 codec will be transmitted and received together using the RTP protocol in a media transmission session using the transmission and reception port number 20000.

At this time, for example, based on (or, with respect to) the received packets of the first RTC end, the first media transmission session may include RTP packets having a transmission IP address of 198.51.110.1, a transmission port number of 20000, a reception IP address of 198.51.100.1, and a reception port number of 10000. At this time, the RTP packet may include video data or audio data and may include an RTP extension header including a MID value. The first RTC end and/or the network may identify an RTP stream to which an RTP packet having an RTP extension header with an MID value of “foo” among the RTP packets of the first media transmission session belongs as a media stream including voice media following the media parameters described in the first media description (the “m=” line) of [Table c] and/or [Table d] described above. The first RTC end and/or the network may identify an RTP stream to which an RTP packet having an RTP extension header with a MID value of “bar” belongs as a media stream including video media following the media parameters described in the second media description (the “m=” row) of [Table c] and/or [Table d]. Note that in the above-described embodiment, the SSRC value for identifying each RTP stream during the SDP Offer/Answer exchange process is not determined. The above SSRC value may be determined at the time of media transmission using the RTP stream, an RTC end and/or network device that receives an RTP packet belonging to the above RTP stream may identify the associated media description (the “m=” line) using the MID value of the RTP extension header included in the above RTP packet, and the RTC endpoint and/or network device may generate mapping information between the SSRC field value and the media description (the “m=” line).

In a real-time communication system according to the present disclosure, a media transmission session may include one or more media streams having the same media format. As an example, the following [Table e] shows an SDP Offer generated by a first RTC end having two cameras.

TABLE e

...
c=IN IP4 198.51.100.1
m=video 10000 RTP/AVP 99
a=rtpmap:99 H264/90000
a=ssrc:193 cname:user@example.com
a=ssrc:938 cname:user@example.com

At this time, additional information about each RTP stream may be passed to RTCP.

For example, based on (with respect to) the received packets of the second RTC end (IP address 198.51.110.1, video transmission/reception port 200) that accept the SDP Offer of the above [Table e], the first media transmission session may include RTP packets with a transmission IP address of 198.51.100.1, a transmission port number of 10000, a reception IP address of 198.51.110.1, and a reception port number of 20000. At this time, the above media transmission session may include two video media streams, and for example, the first video media stream may be an RTP stream with an SSRC field value of 193, and the second video media stream may be an RTP stream with an SSRC field value of 938.

### [Media Stream Filtering Provisioning Information]

The provisioning procedure of the media streaming service according to the disclosure may be implemented as a process of generating, acquiring, and/or updating the Provision Session resource using a Rest-API or the like. Table 1 below is an example of the Provisioning Session resource according to an embodiment of the disclosure.

TABLE 1

| Property name | Type | Cardinality | Description |
|---|---|---|---|
| provisioningSessionId | ResourceId | 1 . . . 1 | Unique identifier |
| | | | allocated to |
| | | | provisioning |
| | | | session |
| provisioningSessionType | ProvisioningSessionType | 1 . . . 1 | This may indicate |
| | | | a downlink |
| | | | streaming or |
| | | | uplink |
| | | | streaming as a |
| | | | type of |
| | | | Provisioning |
| | | | Session. |
| externalServiceId | String | 1 . . . 1 | Identifier |
| | | | indicating |
| | | | service |
| | | | associated with |
| | | | Provisioning |
| | | | Session |
| aspId | AspId | 0 . . . 1 | Identifier |
| | | | indicating |
| | | | application |
| | | | service provider |
| | | | associated with |
| | | | Provisioning |
| | | | Session |
| appId | ApplicationId | 1 . . . 1 | Identifier |
| | | | indicating |
| | | | application |
| | | | associated with |
| | | | Provisioning |
| | | | Session |
| policyTemplateIds | arrya{ResourceId} | 0 . . . 1 | Policy template |
| | | | identifiers |
| | | | associated with |
| | | | Provisioning |
| | | | Session |
| edgeResourceConfigurationIds | array{ResourceId} | | Edge server |
| | | | configuration |
| | | | identifiers |
| | | | associated with |
| | | | Provisioning |
| | | | Session |
| protocolDescription | ProtocolDescription | 0 . . . 1 | Protocol-related |
| | | | information |
| | | | associated with |
| | | | Provisioning |
| | | | Session |
| . . . | | | |

The Provisioning Session Resource according to an embodiment of the disclosure may include media stream filtering provisioning information. For example, the media stream filtering provisioning information may be included in the protocolDescription property and applied to the entire provisioning session, or may be included in a resource referenced by the Provisioning Session Resource and applied only to specific configurations. For example, the media stream filtering provisioning information may be configured for each policy template or for each edge server configuration. Table 2 below is an example of the Policy Template resource according to an embodiment of the disclosure.

TABLE 2

| Property name | Type | Cardinality | Description |
|---|---|---|---|
| policyTemplateId | ResourceId | 1 . . . 1 | This corresponds to an |
| | | | identifier of the Policy |
| | | | Template and has a unique |
| | | | value in the session. |
| state | string | 1 . . . 1 | Property indicating |
| | | | current state of handling |
| | | | Policy Template This may |
| | | | have a value of READY, |
| | | | PENDDING, or the like, |
| | | | for example. |
| stateReason | ProblemDetails | 1 . . . 1 | Detailed information for |
| | | | current state of handling |
| | | | Policy Template |
| externalReference | string | | This corresponds to an |
| | | | additional identifier of the |
| | | | Policy Template and has a |
| | | | unique value in the |
| | | | session. This may be |
| | | | referenced from media |
| | | | transport-related |
| | | | metadata. (For example, |
| | | | HD_Premium and L4S) |
| applicationSessionContext | array(object) | 0 . . . 1 | This corresponds to |
| | | | information for the |
| | | | context of an application |
| | | | session and may include a |
| | | | network slice identifier or |
| | | | a data network identifier. |
| qoSSpecification | array(M1QoSSpecification) | 0 . . . 1 | QoS information to be |
| | | | applied to media transport |
| | | | session associated with |
| | | | this policy template This |
| | | | may include information |
| | | | such as a bitrate or packet |
| | | | loss rate. |
| chargingSpecification | CharginSpecification | 0 . . . 1 | Billing information to be |
| | | | applied to media transport |
| | | | session associated with |
| | | | this policy template |
| protocolDescription | ProtocolDescription | 0 . . . 1 | Protocol-related |
| | | | information associated |
| | | | with Provisioning Session |
| . . . | | | |

A qoSSpecification property or protocolDescription property of the Policy Template resource according to the disclosure may include media stream filtering provisioning information.

The media stream filtering provisioning information according to the disclosure may include at least a portion of following information:
appProtocolFilterSupport: This indicates whether media stream filtering is supported. In case that this is included in the protocolDescription property of the Provisioning Session Resource, this indicates whether all media traffic associated with the Provisioning Session is supported. In case that this is included in a resource referenced by the Provisioning Session Resource, this indicates whether media traffic associated with the resource is supported. In case that this is included in the qoSSpecification property of the Policy Template resource, this indicates whether media traffic to which associated MIQoSSpecification is applied is supported.
transportProtocol: An Identifier(s) of media transport protocol for supporting the media streaming filtering. For example, this may include an additional property for media stream filtering depending on the transport protocol, such as transmission control procotol (TCP), real-time transport protocol (RTP) over user data protocol (UDP), Quick UDP Internet Connections (QUIC), and Stream Control Transmission Protocol (SCTP). For example, when using RTP over UDP, the RTP extension header related information for identifying the media stream may be additionally included.
defaultPSI: a PDU Set Importance value to be applied to a packet to which the PDU Set Marking is not used when PDU Set-based QoS provisioning is applied

The Media AF 121 according to the disclosure may configure the Media AS (e.g., the Media AS 122 in FIG. 6) based on the provisioning information including the media stream filtering provisioning information. For example, the Media AS configuration procedure may be implemented as a process of generating, acquiring, and/or updating the AsResouceConfiguration resource using a Rest-API or the like. For example, the AsResouceConfiguration resource may include media stream filtering AS configuration information including at least one of following information:
appProtocolFilterSupport: This indicates whether media stream filtering is supported.
transportProtocol: An Identifier(s) of media transport protocol for supporting the media streaming filtering. For example, this may include an additional property for media stream filtering depending on the transport protocol, such as TCP, RTP over UDP, QUIC, and SCTP. For example, when using RTP over UDP, the RTP extension header related information for identifying the media stream may be additionally included.

According to an embodiment, whether media stream filtering is supported may be expressed explicitly using the appProtocolFilterSupport information described above, or indirectly by including a media stream identification method in an available packet filter format.

Table 3 is an example of an SdfMethod enumeration data format according to the disclosure, which may represent supportable filtering methods, including media stream filtering.

TABLE 3

| Enumeration value | Description |
|---|---|
| 5_TUPLE | Service data flow is defined by the 5-tuple |
| 5_TUPLE_SUBSTREAM | The service data flow and a sub-stream thereof are defined |
| | through the 5-tuple and the application layer protocol filter |
| 2_TUPLE | The service data flow is defined by a source IP address and a |
| | destination IP address |
| 2_TUPLE_SUBSTREAM | The service data flow and a sub-stream thereof are defined |
| | through the 2-tuple and the application layer protocol filter |
| TYPE_OF_SERVICE_MARKING | The service data flow is defined by Type of Service (TOS) |
| | marking |
| FLOW_LABEL | The service data flow is defined by Ipv6 flow label marking |
| DOMAIN_NAME | Service data flow is defined by a domain name |
| . . . | |

Although the embodiment of the SdfMethod enumeration data format described in the Table 3 above expresses only whether the media stream is identified by an enumeration value, in other embodiments, a detailed parameter for media stream identification may be expressed by an enumeration value. For example, the SdfMethod enumeration data format may include at least one of following enumeration values:
5_TUPLE_RTP_SSRC: The service data flow and a sub-stream thereof are defined by the 5-tuple and the value of the SSRC field of the RTP header.
5_TUPLE_RTP_HE: The service data flow and a sub-stream thereof are defined by the 5-tuple and the RTP extension header Detailed information about the RTP extension header to be used may be determined when configuring dynamic policy information.
5_TUPLE_RTP_HE_{RtpHeaderExtType}: The service data flow and a sub-stream thereof are defined by an RTP extension header value defined by the 5-tuple and RtpHeaderExtType corresponds to a Uniform Resource Identifier (URI) of an extension header registered to Internet Assigned Numbers Authority (IANA) or a value configured to be mapped to the URI of the extension header. For example, a value of RtpHeaderExtType may correspond to “urn: ietf:params:rtp-hdrext:sdes:rtp-stream-id” or the only character string (e.g., RTP_STREAM_ID) defined by the service provider to correspond to same and may mean that the sub-stream is defined by the value of the RtpStreamId field of the RTP extension header, which is defined by the value of RtpHeaderExtType described above. For example, the value of RtpHeaderExtType may correspond to “urn:ietf:params:rtp-hdrext:sdes:mid” or the only character string (e.g., MID) defined by the service provider to correspond to same and may mean that the sub-stream is defined by the value of the identification-tag of the RTP extension header, which is defined by the value of RtpHeaderExtType described above.
2_TUPLE_RTP_SSRC, 2_TUPLE_RTP_HE, 2_TUPLE_RTP_HE_{RtpHeaderExtType}: This may have the same meaning as 5_TUPLE_RTP_SSRC, 5_TUPLE_RTP_HE, and 5_TUPLE_RTP_HE_{RtpHeaderExtType} respectively, except that 2-tuples is used instead of 5-tuples.

Information of a SdfMethod enumeration format according to the disclosure may be included in a resource referenced as an identifier provided by the Provisioning Session Resource or the Provisioning Session Resource described above.

### [Media Stream Filtering Dynamic Policy Information]

The dynamic policy invocation procedure of the media service according to the disclosure may be implemented as a process of generating, acquiring, and/or updating the Dynamic Policy resource using a Rest-API or the like. Table 4 below is an example of the Dynamic Policy resource according to an embodiment of the disclosure.

TABLE 4

| Property name | Type | Cardinality | Description |
|---|---|---|---|
| dynamicPolicyId | ResourceId | 1 . . . 1 | Unique identifier of this |
| | | | dynamic policy |
| provisioningSessionId | ResourceId | 1 . . . 1 | Unique identifier of |
| | | | associated provisioning |
| | | | session |
| sessionId | MediaDeliverySessionId | 1 . . . 1 | Unique identifier of |
| | | | associated media transport |
| | | | session |
| policyTemplateId | ResourceId | 1 . . . 1 | Identifier of policy template |
| | | | to be applied to application |
| | | | data flow |
| applicationFlowBindings | array{ApplicationFlow | 1 . . . 1 | Service Data Flow-related |
| | Binding} | | information to be applied to |
| | | | this dynamic policy |
| qoSEnforcement | boolean | 0 . . . 1 | Indicator indicating whether |
| | | | QoS requirement described in |
| | | | qoSSpecification is being |
| | | | satisfied in 5G system |
| . . . | | | |

The applicationFlowBinding property of the Dynamic Policy resource according to the disclosure may include dynamic policy information for each media stream. Table 5 below is an example of the applicationFlowBinding property according to an embodiment of the disclosure.

TABLE 5

| Property name | Type | Cardinality | Description |
|---|---|---|---|
| componentIdentifier | string | 1 . . . 1 | service component identifier |
| | | | belonging to associated |
| | | | Policy Template |
| applicationFlowDescriptions | array(ApplicationFlow | 1 . . . 1 | Application flow-related |
| | Description) | | information to be managed |
| | | | by associated Dynamic |
| | | | Policy. This may be used to |
| | | | identify application packet |
| | | | traffic in the network. |
| qosSpecification | M5QoSSpecification | 0 . . . 1 | This corresponds to network |
| | | | QoS requirement |
| | | | information to be applied to |
| | | | the application flow |
| | | | described as |
| | | | applicationFlowDescriptions |
| | | | above. If omitted, a network |
| | | | QoS requirement provided |
| | | | by a service component |
| | | | identified by |
| | | | componentIdentifier in the |
| | | | associated Policy Template |
| | | | may be applied |
| . . . | | | |

Table 6 below is an example of the ApplicationFlowDescription data format according to the disclosure.

TABLE 6

| Property name | Type | Cardinality | Description |
|---|---|---|---|
| filterMethod | SdfMethod | 1 . . . 1 | Format of information |
| | | | required for identifying |
| | | | packet belonging to |
| | | | application flow |
| packetFilter | IpPacketFilterSet | 0 . . . 1 | Field values of packet |
| | | | header required for |
| | | | identifying packet |
| | | | belonging to application |
| | | | flow |
| domainName | string | 0 . . . 1 | Address of server for |
| | | | identifying application |
| | | | flow For example, FQDN |
| | | | (Fully-Quantified Domain |
| | | | Name) |
| defaultPSI | number | 0 . . . 1 | Default PSI value to be |
| | | | applied to application flow |
| | | | in case that PDU Set-based |
| | | | QoS is applied. |
| | | | Replacement to this may be |
| | | | performed in case that |
| | | | PDU Set marking is |
| | | | applied to a sub-stream |
| | | | further categorized by |
| | | | ProtocolDescription, or a |
| | | | defaultPSI is present in the |
| | | | ProtocolDescription. |
| mediaTransportParameters | array(ProtocolDescription) | 0 . . . 1 | Information required for |
| | | | PDU Set identification or |
| | | | media transport stream |
| | | | identification |
| . . . | | | |

ProtocolDescription according to the disclosure may include protocol information applied to the service data flow and may further include information for sub-stream identification according to the applied protocol. Table 7 below is an example of the ProtocolDescription data format according to the disclosure.

TABLE 7

| Property name | Type | Cardinality | Description |
|---|---|---|---|
| transportProto | array(MediaTransportProto) | 0 . . . 1 | Identifier indicating transport |
| | | | protocol used in associated |
| | | | application flow |
| defaultPSI | number | 0 . . . 1 | Default PSI value to be |
| | | | applied to protocol packet |
| | | | identified by transportProto |
| | | | value in associated application |
| | | | flow in case that PDU Set- |
| | | | based QoS is applied. |
| | | | Replacement to this may be |
| | | | performed in case that PDU |
| | | | Set Marking is applied or |
| | | | detailed filtering information |
| | | | of RTCP packet and PSI value |
| | | | are given through |
| | | | rtpPayloadInfoList |
| rtpStreamFilter | array(integer) | 0 . . . 1 | SSRC field value of RTP |
| | | | packet to be used for sub- |
| | | | stream identification |
| rtpHeaderExtInfo | array(RtpHeaderExtInfo) | 0 . . . 1 | RTP extension header-related |
| | | | information used for sub- |
| | | | stream identification or PDU |
| | | | Set Marketing |
| rtpPayloadInfoList | array(RtpPayloadInfo) | 0 . . . 1 | RTP payload information for |
| | | | sub-stream identification or |
| | | | PDU Set-related information |
| | | | extraction |
| . . . | | | |

The MediaTransportProto format in Table 7 indicates a protocol used in the associated application flow. For example, the MediaTransportProto format may have an enumeration format including at least one of following protocols:
RTP, SRTP (secure RTP), RTCP (RTP Control Protocol), DTLS (Datagram Transport Layer Security), STUN (Session Traversal Utilities for NAT)

Here, rtpStreamFilter, rtpHeaderExtInfo, rtpPayloadInfoList properties in Table 7 may be applicable in case that protocols such as RTP, SRTP, or STUN encapsulating RTP/SRTP are used.

For example, in case that an RTP or SRTP protocol is to be used, a RtpHeaderExtInfo data format included in rtpHeaderExtInfo may include at least a portion of following information:

rtpHeaderExtType: An identifier indicating a format of the RTP extension header. This corresponds to a URI of an extension header registered to Internet Assigned Numbers Authority (IANA) or a value configured to be mapped to the URI of the extension header. For example, a value of RtpHeaderExtType may correspond to “urn:ietf:params:rtp-hdrext:sdes:rtp-stream-id” or the only character string (e.g., RTP_STREAM_ID) defined by the service provider to correspond to same and may mean that the sub-stream is defined by the value of the RtpStreamId field of the RTP extension header, which is defined by the value of RtpHeaderExtType described above. For example, the value of RtpHeaderExtType may correspond to “urn:ietf:params:rtp-hdrext:sdes:mid” or the only character string (e.g., MID (e.g., media stream identity (ID)) defined by the service provider to correspond to the same and may mean that the sub-stream is defined by the value of the identification-tag of the RTP extension header, which is defined by the value of RtpHeaderExtType described above.
rtpHeaderExtId: An ID field of the RTP extension header identified by an associated rtpHeaderExtType value.
rtpHeaderExtStreamId: A field name usable as a media stream identifier in the RTP extension header identified by an associated rtpHeaderExtType value.

For example, in case that the RTCP protocol is used, the rtpStreamFilter and rtpHeaderExtInfo properties are not present and the defaultPSI property may be present. In addition, a PSI value for each RTCP message may be provided as the rtpPayloadInfoList property. For example, the RtpPayloadInfo data format included in rtpPayloadInfoList may include at least a portion of following information:
RtpPayloadType: An RTP payload format. This may be indicated by at least one of a PT field value in the RTP/RTCP packet header, a payload format name, or an abbreviation. For example, PT=205 may indicate Generic RTP Feedback and may be represented as “RTPFB”. For another example, PT=206 and 207 may indicate Payload-specific and extended report, respectively, and may be represented as “PSBF” and “XR”.
RtpPayloadFormat: A detailed payload format according to the RTP payload identified by RtpPayloadType. This may be indicated by at least one of a FMT field value in the RTP/RTCP packet header, a payload format name, or an abbreviation. For example, in case that PT=206 (“PSBF”), FMT=1 may indicate a Picture Loss Indication and may be represented as “PLI”.
PSI: This indicates a PSI value to be applied to the RTCP packet identified by an RtpPayloadType property value or a combination of the RtpPayloadType property value and an RtpPayloadFormat property value.
RtpPayloadFilter: RTP payload-based stream identification information. For example, the value of “RTP_PAYPLOAD_TYPE” or “RTP_PAYLOAD_TYPE” may mean that the PT field value or FMT field value of the RTP/RTCP packet is used as stream identification information, respectively. For example, the value of “ALL” may mean that a combination of the PT field value and FMT field value of the RTP/RTCP packet is used as a stream identification information.

For example, the information for sub-stream identification in case that the RTP or SRTP protocol is used may include a combination of the information provided by the rtpStreamFilter property, the rtpHeaderExtInfo property and/or the rtpPayloadInfoList property. That is, the filtering information for sub-stream identification may include a combination of the SSRC field value(s), the PT field value(s), the FMT field value(s), and/or the RTP extension header(s) in the RTP packet header.

The embodiments described above are specific examples for identifying sub-streams in the case of using RTP/SRTP (secure RTP), and an additional sub-stream identifier at the sub-protocol level may be required in case that the RTP/SRTP protocol is encapsulated as a payload of another sub-protocol such as STUN.

The embodiments described above illustrate, for example, that the service data flow is defined by information provided as a property in the IpPacketFilterSet format, and the sub-stream is defined by information provided as a property in the ProtocolDescription format. However, this is for illustrative purposes only and it is also possible to consider the sub-stream as a service data flow and provide IP and transport protocol (e.g., TCP or UDP) packet-level information and application layer protocol-level information in a single property.

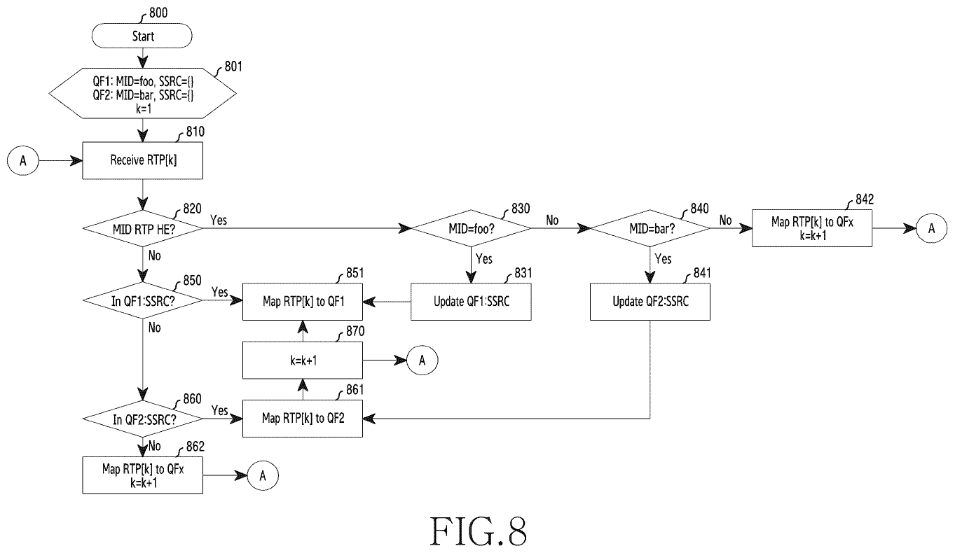

FIG. 8 illustrates an example packet filter operation according to the disclosure.

Referring to FIG. 8, the sub-stream identification information according to an embodiment of the disclosure may include the RTP extension header-related information, but may not include the SSRC field value. For example, the RTP extension header-related information may include at least one of the formats of the RTP extension header including a sub-stream identifier, an identifier for identifying the RTP extension header in the RTP packet, or a sub-stream identifier value. The packet filter according to the disclosure may dynamically generate and manage a substream-SSRC mapping table, which is a list of SSRC field values included in the sub-stream.

For example, the case, where a sub-stream is defined by the identification-tag field value of the RTP extension header, defined as “urn:ietf:params:rtp-hdrext:sdes:mid”, is described below. For example, the RTP extension header defined as “urn:ietf:params:rtp-hdrext:sdes:mid” may be transport as the RTP extension header having an ID field value of 5 as a result of the SDP negotiation. The first sub-stream may be defined as RTP streams including an RTP extension header having an identification-tag field value of “foo” representing the MID. The second sub-stream may be defined as RTP streams including an RTP extension header having an identification-tag field value of “bar”. Here, not all RTP packets in an RTP stream may include an RTP extension header having an ID field value of 5. For example, the media transport apparatus may include an RTP extension header having an ID field value of 5 in an RTP packet and transport the same only for a predetermined time period at a time point at which the transport of the RTP stream to the media reception apparatus is initiated, and then include an RTP extension header having an ID field value of 5 in specific RTP packets and transport same according to a predetermined interval. The media transport apparatus and the media reception apparatus may correspond to the UE and the Media AS, for example.

The network according to the disclosure may configure the first QOS flow with the first sub-stream and configure the second QoS flow with the second sub-stream. For example, information of the IP and UDP layer and/or protocol information (e.g., RTP) of the first QoS flow and the second QoS flow may be substantially the same.

Referring to FIG. 8, the packet filter at the sub-stream level according to the disclosure may operate as follows.

Operation 800: An operation for packet filter configuration may be initiated.

Operation 801: Initial information for a sub-stream-QOS mapping table for each QoS flow may be configured. For example, the initial information may be configured by the PCF 113 based on information provided by the AF 121 to the PCF 113 and/or by the UPF 103 based on information provided to the SMF 112 to the UPF 103 (e.g., a packet filter inside the UPF may be configured based on information transferred in the order AF, PCF, SMF, and UPF). For example, the AF 121 may transfer first information to the PCF 113, and the PCF 113 may transfer the first information to the UPF 103 (through the SMF 112) based on the first information. The UPF 103 may configure a packet filter based on the transferred first information.

For example, the first QOS flow QF1 may include a sub-stream defined by the MID value “foo” and a list of RTP stream identifiers (SSRCs) belonging to the sub-stream may not yet be defined. For example, the second QoS flow QF2 may include a sub-stream defined by the MID value “bar” and a list of RTP stream identifiers (SSRCs) belonging to the sub-stream may not yet be defined. The initial value of the packet number k may be configured to be 1.

Operation 810: A k-th packet filter RTP[k] may be input to the packet filter.

Operation 820: In case that RTP[k] includes an RTP extension header (MID RTP HE) having an ID field value of 5, operation 830 may be performed, or operation 850 may be performed otherwise.

Operation 830: In case that an identification-tag value of the MID RTP HE is the same as “foo”, operation 831 may be performed, otherwise operation 840 may be performed.

Operation 831: In case that a value of the SSRC field of RTP[k] is not included in the SSRC list of the first QoS flow QF1, the packet filter may add the value of the SSRC field of RTP[k] to the SSRC list and perform operation 851.

Operation 840: In case that an identification-tag value of the MID RTP HE is the same as “bar”, the packet filter may perform operation 841 and may perform operation 842 otherwise.

Operation 841: In case that a value of the SSRC field of RTP[k] is not included in the SSRC list of the second QoS flow QF2, the packet filter may add the value of the SSRC field of RTP[k] to the SSRC list and perform operation 861.

Operation 842: The packet filter may allocate RTP[k] to a third QoS flow and perform operation 810 to handle a next reception packet (k=k+1). Here, the third QoS flow may correspond to a QoS flow substantially identical to the first QoS flow or the second QoS flow. For example, in case that the first QoS flow includes a sub-stream for transporting voice data and the second QOS flow includes a sub-stream for transporting image data, and in case that RTP[k] is a packet for transporting voice data, RTP[k] may be allocated to the third QoS flow (e.g., the second QoS flow). That is, the third QoS flow may correspond to an existing flow (e.g., the second QoS flow) rather than a newly generated QoS flow. For example, the third QoS flow may be an existing QOS flow, and a QoS requirement thereof may follow policies of the network and/or the service operator.

Operation 850: The packet filter may perform operation 851 in case that the value of the SSRC field of RTP[k] is included in the SSRC list (QF1:SSRC={ . . . }) of the first QOS flow, and may perform operation 860 otherwise.

Operation 851: The packet filter may allocate RTP[k] to the first QoS flow and perform operation 870.

Operation 860: The packet filter may perform operation 861 in case that a value of the SSRC field of RTP[k] is included in the SSRC list (QF2:SSRC={ . . . }) of the second QoS flow, and may perform operation 860 otherwise.

Operation 861: The packet filter may allocate RTP[k] to the second QoS flow and perform operation 870.

Operation 862: The packet filter may allocate RTP[k] to the third QoS flow and perform operation 810 to handle the next reception packet (k=k+1). Here, the third QoS flow may correspond to a QoS flow substantially identical to the first QoS flow or the second QoS flow. For example, in case that the first QoS flow includes a sub-stream for transporting voice data and the second QoS flow includes a sub-stream for transporting image data, and in case that RTP[k] is a packet for transporting voice data, RTP[k] may be allocated to the third QOS flow (e.g., the second QoS flow). For example, the third QOS flow may be an existing QoS flow and a QoS requirement thereof may follow policies of the network and/or the service operator.

Operation 870: The packet filter may perform operation 810 to handle the next reception packet (k=k+1).

The sub-stream, according to an embodiment of the disclosure, may include an RTCP packet. One UDP datagram may include one or more RTCP packets, and the RTCP packets included in one UDP datagram may be referred to as compound RTCP packets. A second word (from a fifth byte to an eighth byte) of a compound RTCP packet may include an SSRC value of a synchronization source configured to transmit the RTCP packet. For example, the compound RTCP packet may include a source description (SDES) RTCP packet having a MID value as an item, which is used as a sub-stream identifier.

Here, the packet filter according to an embodiment of the disclosure may be mapped to the QoS flow based on an SSRC field value of an RTP synchronization source associated with the RTCP packet. For example, a synchronization source identified by the SSRC value may be a synchronization source that transmits both RTP and RTCP packets, or may be a synchronization source that transmits only RTCP packets.

According to an embodiment, there may be an issue where the packet filter illustrated in FIG. 8 generates the SSRC list for the QoS flow based on the MID RTP header extension (HE) and the SSRC value of the RTP packet, so the SSRC value of the synchronization source that only transmits RTCP packets may not be added to the list. Therefore, when the RTCP packet is input, the packet filter according to an embodiment of the disclosure may identify the MID item value of the SDES RTCP packet as the sub-stream identifier and determine the QoS flow associated with the RTCP packet.

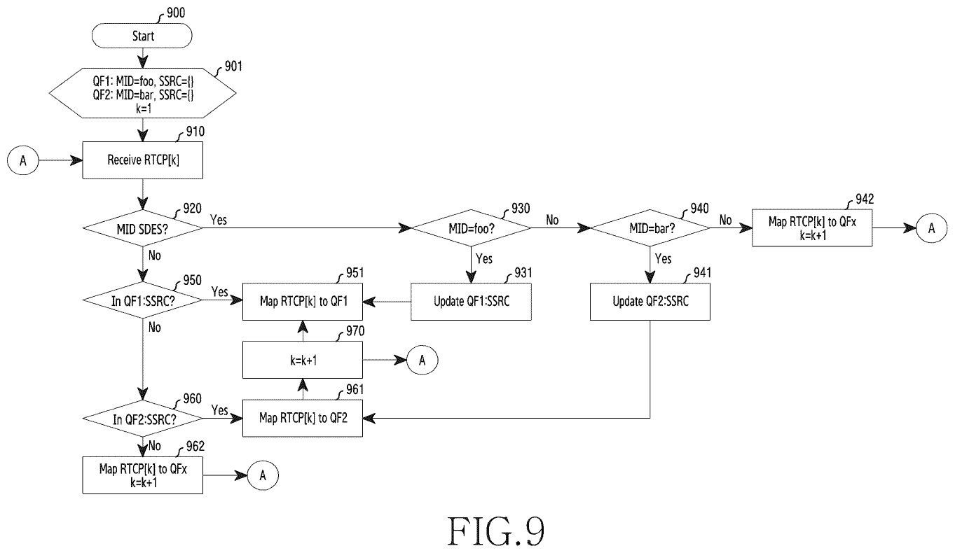

FIG. 9 illustrates an example RTCP packet filter operation according to the disclosure. Referring to FIGS. 8 and 9, the procedures disclosed in FIG. 9 may be identical to the procedures disclosed in FIG. 8 except the following:
Packets received at operation 910 may be (compound) RTCP packets rather than RTP packets.
In operation 920, it is possible to identify whether an SDES RTCP packet that is not an RTP extension header includes an MID item. For example, the RTCP packet may not include an extension header.
In operations 950 and 960, a location (from a fifth byte to an eighth byte) of the SSRC field of the RTCP packet may be different from a location (from a ninth byte to a twelfth byte) of the SSRC field of the RTP packet.
In operation 942, 951, 961 and/or 962, the (compound) RTCP packet rather than the RTP packet may be allocated to the QoS flow.

The flowcharts of FIGS. 8 and 9 above illustrate the process when the RTP packet and the RTCP packet are input, respectively, but may also be applicable to an input stream with multiplexed RTP and RTCP packets. Here, the SSRC list for each QoS flow may be operated separately or integrally for the RTP packet and the RTCP packet.

Operations 901, 910, 920, 930, 931, 940, 941, 942, 950, 951, 960, 961, 962, and 970 of FIG. 9 of the disclosure, in order, unless contradictory (or, unless otherwise defined), may correspond to operation 801, 810, 820, 830, 831, 840, 841, 842, 850, 860, 861, 862, and 870 of FIG. 8.

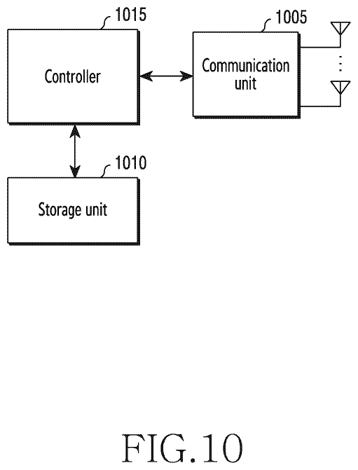

FIG. 10 illustrates an example functional structure of a base station according to an embodiment of the disclosure.

Referring to FIG. 10, the structure according to an embodiment illustrated in FIG. 10 may be understood as a structure of the NG-RAN (e.g., next generation node B (gNB) or eNB) 102 in FIG. 1. As used herein, such terms as “ . . . unit” and “ . . . er” refer to a unit configured to process at least one function or operation, and may be implemented as hardware, software, or a combination of hardware and software.

According to an embodiment, the base station may include a communication unit 1005, a storage unit 1010, and/or a controller 1015.

The communication unit 1005 performs functions for transmitting/receiving signals through a radio channel. For example, the communication unit 1005 performs functions of conversion between baseband signals and bitstrings according to the physical layer specifications of the system. For example, during data transmission, the communication unit 1005 generates complex symbols by encoding and modulating a transmission bitstream. In addition, during data reception, the communication unit 1005 demodulates and decodes a baseband signal to restore a received bitstring. In addition, the communication unit 1005 up-converts a baseband signal to an RF band signal, transmits the same through an antenna, and down-converts an RF band signal received through the antenna to a baseband signal. For example, the communication unit 1005 may include a transmission filter, a reception filter, an amplifier, a mixer, an oscillator, a DAC, and an ADC.

In addition, the communication unit 1005 may include multiple transmission/reception paths. Moreover, the communication unit 1005 may include at least one antenna array including multiple antenna elements. In terms of hardware, the communication unit 1005 may include a digital circuit and an analog circuit (e.g., a radio frequency integrated circuit (RFIC)). The digital circuit and analog circuit may be implemented as a single package. In addition, the communication unit 1005 may include multiple RF chains. Furthermore, the communication unit 1005 may perform beamforming.

The communication unit 1005 transmits and receives signals as described above. Accordingly, all or part of the communication unit 1005 may be referred to as a “transmitter”, a “receiver”, or a “transceiver”. In addition, as used in the following description, the meaning of “transmission and reception performed through a radio channel” includes the meaning that the above-described processing is performed by the communication unit 1005.

The storage unit 1010 may store basic programs, application programs, and data, such as configuration information, for operation of the main base station. The storage unit 1010 may include a volatile memory, a nonvolatile memory, or a combination of a volatile memory and a nonvolatile memory. In addition, the storage unit 1010 provides the stored data at the request of the controller 1015.

The controller 1015 controls the overall operation of the base station. For example, the controller 1015 transmits/receives signals through the communication unit 1005. In addition, the controller 1015 records data in the storage unit 1010 and reads the data from the storage unit 1010. In addition, the controller 1015 may perform functions of protocol stacks required by communication specifications. To this end, the controller 1015 may include at least one processor or microprocessor, or may be a part of a processor. In addition, a part of the communication unit 1005 and the controller 1015 may be referred to as a communication processor (CP). According to various embodiments, the controller 1015 may control to perform synchronization by using a wireless communication network. For example, the controller 1015 may control the base station to perform operations according to various embodiments described above.

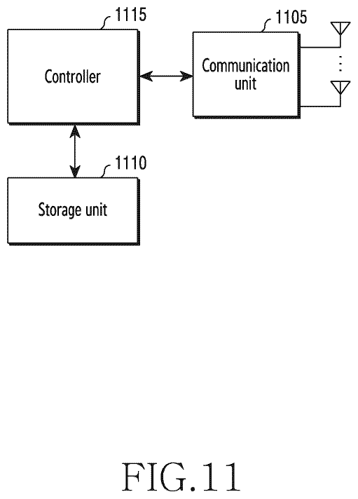

FIG. 11 illustrates an example of a functional structure of a UE according to an embodiment of the disclosure. The structure illustrated in FIG. 11 may be understood as a structure of the UE 101 in FIG. 1. As used herein, such terms as “ . . . unit” and “ . . . er” refer to a unit configured to process at least one function or operation, and may be implemented as hardware, software, or a combination of hardware and software.

Referring to FIG. 11, the UE may include a communication unit 1105, a storage unit 1110, and/or a controller 1115.

The communication unit 1105 performs functions for transmitting/receiving signals through a radio channel. For example, the communication unit 1105 performs functions of conversion between baseband signals and bitstrings according to the physical layer specifications of the system. For example, during data transmission, the communication unit 1105 generates complex symbols by encoding and modulating a transmission bitstream. In addition, during data reception, the communication unit 1105 demodulates and decodes a baseband signal to restore a received bitstring. In addition, the communication unit 1105 up-converts a baseband signal to an RF band signal, transmits the same through an antenna, and down-converts an RF band signal received through the antenna to a baseband signal. For example, the communication unit 1105 may include a transmission filter, a reception filter, an amplifier, a mixer, an oscillator, a DAC, and an ADC.

In addition, the communication unit 1105 may include multiple transmission/reception paths. Moreover, the communication unit 1105 may include at least one antenna array including multiple antenna elements. In terms of hardware, the communication unit 1105 may include a digital circuit and an analog circuit (e.g., a radio frequency integrated circuit (RFIC)). The digital circuit and analog circuit may be implemented as a single package. In addition, the communication unit 1105 may include multiple RF chains. Furthermore, the communication unit 1105 may perform beamforming.

The communication unit 1105 transmits and receives signals as described above. Accordingly, all or part of the communication unit 1105 may be referred to as a “transmitter”, a “receiver”, or a “transceiver”. In addition, as used in the following description, the meaning of “transmission and reception performed through a radio channel” may include the meaning that the above-described processing is performed by the communication unit 1105.

The storage unit 1110 may store basic programs, application programs, and data, such as configuration information, for operation of the main base station. The storage unit 1110 may include a volatile memory, a non-volatile memory, or a combination of a volatile memory and a non-volatile memory. In addition, the storage unit 1110 provides the stored data at the request of the controller 1115.

The controller 1115 controls the overall operation of the UE. For example, the controller 1115 transmits/receives signals through the communication unit 1105. In addition, the controller 1115 records data in the storage unit 1110 and reads the data from the storage unit 1110. In addition, the controller 1115 may perform functions of protocol stacks required by communication specifications. To this end, the controller 1115 may include at least one processor or microprocessor, or may be a part of a processor. In addition, a part of the communication unit 1105 and the controller 1115 may be referred to as a communication processor (CP). According to various embodiments, the controller 1115 may perform synchronization by using a wireless communication network. For example, the controller 1115 may control the UE to perform operations according to various embodiments described below.

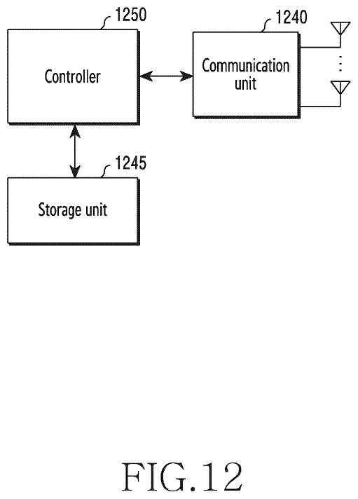

FIG. 12 illustrates an example functional structure of a core network entity according to an embodiment of the disclosure. A structure of a core network entity in a wireless communication system according to various embodiments of the disclosure is illustrated. The structure illustrated in FIG. 12 may be understood as a structure of a device having at least one function among the network entities (e.g., SMF 112, AMF 111, and SMF 135) in FIG. 1. As used herein, such terms as “ . . . unit” and “-er” refer to a unit configured to process at least one function or operation, and may be implemented as hardware, software, or a combination of hardware and software.

Referring to FIG. 12, the core network entity may include a communication unit 1240, a storage unit 1245, and a controller 1250.

The communication unit 1240 provides an interface for communicating with other devices in the network. That is, the communication unit 1240 converts a bitstring, transmitted from the core network entity to any other device, into a physical signal, and converts a physical signal, received from any other device, into a bitstring. The communication unit 1240 may transmit/receive signals. Accordingly, the communication unit 1240 may be referred to as a modem, a transmitter, a receiver, or a transceiver. The communication unit 1240 enables the core network entity to communicate with other devices or the system via a backhaul connection (e.g., wired backhaul or wireless backhaul) or via a network.

The storage unit 1245 may store basic programs, application programs, and data, such as configuration information, for operation of the main base station. The storage unit 1245 may be configured by a volatile memory, a nonvolatile memory, or a combination of a volatile memory and a nonvolatile memory. In addition, the storage unit 1245 provides the stored data at the request of the controller 1250.

The controller 1250 controls the overall operation of the core network entity. For example, the controller 1250 transmits/receives signals through the communication unit 1240. In addition, the controller 1250 records data in the storage unit 1245 and reads the data from the storage unit 1245. The controller 1250 may include at least one processor. According to various embodiments, the controller 1250 may control to perform synchronization by using a wireless communication network. For example, the controller 1250 may control the core network entity to perform operations according to various embodiments described below.

It should be noted that the above-described configuration diagrams, illustrative diagrams of control/data signal transmission methods, illustrative diagrams of operation procedures, and structural diagrams as illustrated in FIG. 1 to FIG. 12 are not intended to limit the scope of protection of the disclosure. That is, all the constituent elements, entities, or operation steps shown and described in FIG. 1 to FIG. 12 should not be construed as being essential elements for the implementation of the disclosure, and even when including only some of the elements, the disclosure may be implemented without impairing the true of the disclosure.

The above-described operations of the embodiments may be implemented by providing any unit of a device with a memory device storing corresponding program codes. That is, a controller in the device may perform the above-described operations by reading and executing the program codes stored in the memory device by means of a processor or central processing unit (CPU).

Various units or modules of an entity or terminal device set forth herein may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

The electronic device which implements, operates, and performs various embodiments of the disclosure may be one of various types of electronic devices. The electronic device may include, for example, a portable communication device (e.g., a smart phone), a computer device, a portable multimedia device, a portable medical device, a camera, a wearable device, or a home appliance. The electronic device according to embodiments of the disclosure is not limited to those described above.

It should be appreciated that the embodiments and the terms used therein are not intended to limit the technological features set forth herein to particular embodiments and the disclosure includes various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). In case that an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used in various embodiments of the disclosure, the term “module” may include a unit implemented in hardware, software, or firmware, and may be interchangeably used with other terms, for example, “logic,” “logic block,” “component,” or “circuit”. The “module” may be a single integrated component, or a minimum unit or part thereof, adapted to perform one or more functions. For example, according to an embodiment, the “module” may be implemented in the form of an application-specific integrated circuit (ASIC).

Various embodiments as set forth herein may be implemented as software (e.g., a program) including one or more instructions that are stored in a storage medium (e.g., an internal memory or external memory) that is readable by a machine (e.g., an electronic device). For example, a processor of the machine (e.g., an electronic device) may invoke at least one of the one or more stored instructions from the storage medium, and execute it. This allows the machine to be operated to perform at least one function according to the at least one instruction invoked. The one or more instructions each may include a code generated by a complier or a code executable by an interpreter. The machine-readable storage medium may be provided in the form of a non-transitory storage medium. Herein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, methods according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities may be separately disposed in any other element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE), the method comprising:
transmitting, to an application function (AF) entity for a media streaming, a first message for requesting a dynamic policy applied to a media session for a media; and
receiving, from the AF entity for the media streaming, a second message including information associated with the dynamic policy,
wherein the first message includes first information on a media stream for the media, and second information on a media protocol corresponding to media stream, and
wherein a quality of service (QOS) for the media stream is based on the first information.

2. The method of claim 1, wherein, in case that the media protocol corresponds to a first media protocol, the first information includes an identity (ID) of the media stream, and
wherein the QoS is mapped with the ID of the media stream.

3. The method of claim 1, wherein, in case that the media protocol corresponds to a second media protocol, the first information includes a value of a synchronization source (SSRC) field for the media stream, and
wherein the QoS is mapped with the value of the SSRC field.

4. The method of claim 1, wherein, in case that the media protocol corresponds to a third media protocol, the first information includes a protocol data unit (PDU) set importance (PSI) value, and
wherein the QoS is mapped with the PSI value.

5. The method of claim 1, wherein media streams for the media are mapped with different media protocol,
wherein the media streams includes the media stream, and
wherein the media protocol includes a real time protocol (RTP), secure-RTP (S-RTP), or RTP control protocol (RTCP).

6. A method performed by an application function (AF) entity for a media streaming, the method comprising:
receiving, from a user equipment (UE), a first message for requesting a dynamic policy applied to a media session for a media; and
transmitting, to the UE, a second message including information associated with the dynamic policy,
wherein the first message includes first information on a media stream for the media, and second information on a media protocol corresponding to media stream, and
wherein a quality of service (QOS) for the media stream is based on the first information.

7. The method of claim 6, wherein, in case that the media protocol corresponds to a first media protocol, the first information includes an identity (ID) of the media stream, and
wherein the QoS is mapped with the ID of the media stream.

8. The method of claim 6, wherein, in case that the media protocol corresponds to a second media protocol, the first information includes a value of a synchronization source (SSRC) field for the media stream, and
wherein the QoS is mapped with the value of the SSRC field.

9. The method of claim 6, wherein, in case that the media protocol corresponds to a third media protocol, the first information includes a protocol data unit (PDU) set importance (PSI) value, and
wherein the QoS is mapped with the PSI value.

10. The method of claim 6, wherein media streams for the media are mapped with different media protocol,
wherein the media streams includes the media stream, and
wherein the media protocol includes a real time protocol (RTP), secure-RTP (S-RTP), or RTP control protocol (RTCP).

11. A user equipment (UE) comprising:
at least one transceiver;
at least one processor communicatively coupled to the at least one transceiver; and
at least one memory, communicatively coupled to the at least one processor, storing instructions executable by the at least one processor individually or in any combination to cause the UE to
transmit, to an application function (AF) entity for a media streaming, a first message for requesting a dynamic policy applied to a media session for a media, and
receive, from the AF entity for the media streaming, a second message including information associated with the dynamic policy,
wherein the first message includes first information on a media stream for the media, and second information on a media protocol corresponding to media stream, and
wherein a quality of service (QOS) for the media stream is based on the first information.

12. The UE of claim 11, wherein, in case that the media protocol corresponds to a first media protocol, the first information includes an identity (ID) of the media stream, and
wherein the QoS is mapped with the ID of the media stream.

13. The UE of claim 11, wherein, in case that the media protocol corresponds to a second media protocol, the first information includes a value of a synchronization source (SSRC) field for the media stream, and
wherein the QoS is mapped with the value of the SSRC field.

14. The UE of claim 11, wherein, in case that the media protocol corresponds to a third media protocol, the first information includes a protocol data unit (PDU) set importance (PSI) value, and
wherein the QoS is mapped with the PSI value.

15. The UE of claim 11, wherein media streams for the media are mapped with different media protocol,
wherein the media streams includes the media stream, and
wherein the media protocol includes a real time protocol (RTP), secure-RTP (S-RTP), or RTP control protocol (RTCP).

16. An application function (AF) entity for a media streaming comprising:
at least one processor; and
at least one memory, communicatively coupled to the at least one processor, storing instructions executable by the at least one processor individually or in any combination to cause the AF entity to:
receive, from a user equipment (UE), a first message for requesting a dynamic policy applied to a media session for a media, and
transmit, to the UE, a second message including information associated with the dynamic policy,
wherein the first message includes first information on a media stream for the media, and second information on a media protocol corresponding to media stream, and
wherein a quality of service (QOS) for the media stream is based on the first information.

17. The AF entity of claim 16, wherein, in case that the media protocol corresponds to a first media protocol, the first information includes an identity (ID) of the media stream, and
wherein the QoS is mapped with the ID of the media stream.

18. The AF entity of claim 16, wherein, in case that the media protocol corresponds to a second media protocol, the first information includes a value of a synchronization source (SSRC) field for the media stream, and
wherein the QoS is mapped with the value of the SSRC field.

19. The AF entity of claim 16, wherein, in case that the media protocol corresponds to a third media protocol, the first information includes a protocol data unit (PDU) set importance (PSI) value, and
wherein the QoS is mapped with the PSI value.

20. The AF entity of claim 16, wherein media streams for the media are mapped with different media protocol,
wherein the media streams includes the media stream, and
wherein the media protocol includes a real time protocol (RTP), secure-RTP (S-RTP), or RTP control protocol (RTCP).
